(19) United States
(12) Patent Application Publication
(10) Pub. No.: US 2006/0292324 A1
(43) Pub. Date: Dec. 28, 2006

(54) Uniaxially and biaxially-oriented polytetrafluoroethylene structures

(76) Inventor: Robert Roberts, Ocala, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/451,943

(22) Filed: Jun. 12, 2006

Related U.S. Application Data
(63) Continuation-in-part of application No. 10/810,763, filed on Mar. 26, 2004, now Pat. No. 7,060,210.

(51) Int. Cl. B27J 5/00; B32B 1/08; B29C 65/00; B32B 27/00; B32B 27/18

(52) U.S. Cl. 428/36.91; 264/41; 264/127; 428/422; 428/323; 428/331; 428/313.9

(57) ABSTRACT

The subject invention relates to uniaxially-oriented extrudate and methods for processing the same utilizing colloidal size polytetrafluoroethylene resin particles. Still another aspect of the subject invention relates to the advantage of uniaxially paste extruding colloidal size PTFE particles and particularly micron size fillers and additive up to 90% by volume. Another aspect of the subject invention relates to biaxially-oriented PTFE compositions made from uniaxially-oriented paste extrudate of the invention in the hydrostatic pressure coalescible state. The subject invention also relates to methods for preparing porous biaxially-oriented PFTE compositions utilizing fugitive pore-forming materials and methods for forming shapes from the PTFE composition of the subject invention.

This application is a continuation-in-part of co-pending application U.S. Ser. No. 10/810,763, filed Mar. 26, 2004, which is hereby incorporated by reference in its entirety including any tables, figures, or drawings.

### BACKGROUND OF THE INVENTION

This invention relates to biaxially-oriented polytetrafluoroethylene (“PTFE”) compositions, methods for processing sheet continuously or in reasonably long lengths and widths, uniaxially-oriented filled PTFE extrudate, and apparatus at least partially lined with a sheet prepared from the compositions of the subject invention.

A method for processing PTFE (also known as TEFLON) sheet continuously or in reasonably long lengths and widths has been pursued for over 40 years. For instance, in 1961, two patents, U.S. Pat. Nos. 3,003,912 and 3,010,950, relating to methods for processing sheet continuously or in reasonably long lengths were issued. However, neither process was successful due to various processing problems and property deficiencies. U.S. Pat. No. 3,556,161 also disclosed methods for preparing quality sheet in a batch process.

Typically, PTFE sheet is fabricated by compression molding a cylinder that must be batch sintered (fused), cooled, and finally shaved (skived) in a lathe to obtain the PTFE sheet. Although this process produces a sheet, the sheet does not lay flat, is randomly oriented, and is not stress free. Moreover, this fabrication technique is not cost effective and is time consuming because filled sheet is costly and of limited quality. Filled sheet manufacturing requires special fabrication techniques. For example, preforming pressures are predominantly above 10,000 psi and sintering is usually done confined under pressure in a mold. Filler levels rarely exceed 40% by volume. These conditions limit sheet size and filler content. Fillers also dull the skiving blades used to shave the sheets.

Consequently, there is still a need for filled or unfilled PTFE sheet. Moreover, there is a need for filled PTFE containing more than 50% of fillers.

Until the 1960s, solid materials were called “fillers” and consisted primarily of particulate carbon, graphite, bronze, chopped glass fibers, and several other basic materials employed as inexpensive extenders. In the years that followed, a much broader range of materials have been included, and the term “additives” has come into use and includes, for example, pigments for color coding and polymers. Since the 1960s, both fillers and additives have been used interchangeably. Today, fillers and additives are added to provide many functional purposes and serve to improve the valuable properties of PTFE as a matrix for new products.

The chemical linings industry has developed to inhibit or reduce corrosion of the underlying process apparatus. Corrosion is present in the chemical industry, and linings add an additional protective barrier to delay or prevent vessel failure. Unfortunately, the materials from which these linings are typically prepared, such as lamellae layers of PTFE, PFA, FEP, and PVDF, often encounter problems related to permeation. Some linings are layered structures such as, PVDF, fiberglass reinforced plastic, these layers are not homogeneous, consequently, permeation rates may vary internally and provide pockets where permeating chemicals, liquids, and vapors exposed to cyclic temperature conditions may collect and become trapped thereby beginning the process of liner delamination and ultimate failure. Laminate layers may permeate at different rates developing pockets of permeated chemicals, liquids, vapors, and solids when exposed to cyclic temperature conditions imposed by the underlying process.

Permeation is driven by temperature and temperature differential. The permeants move from hot surfaces to colder surfaces. Consequently, vessels and pipe lines are often heat traced or insulated to dampen the effects of temperature differential.

Additionally, the rate of permeation may be reduced in a polymer system by increasing the barrier lining thickness. In fluoropolymers, the rate of permeation diminishes significantly as the liner thickness is increased. Rate change is significantly reduced at a thickness of about 90 mils (about 0.090 inches) and comfortably reduced at thickness greater than about 125 mils (about 0.125 inches).

Permeability is also decreased by increasing polymer density and molecular weight and improved molecular orientation. PTFE resins have the highest molecular weight of the aforementioned polymers and also exhibit the highest density because of its inherent high degree of crystalline order.

To address the weepage issues related to permeability, most lined chemical vessels and piping systems are provided with weep holes located in the vessel wall in strategic locations to allow any permeating gases or liquids to escape. If the gases or liquids are toxic, weepage must be collected or evacuated.

Also, the lining material structure should be homogenous to limit liner shrinkage, eliminate warpage, and fit snuggly in place against the vessel walls. Unfortunately, stress in the lining material and variation in material density, and molecular structure of the liner can contribute to such problems.

Accordingly, there is a need for a lining material that reduces or prevents permeation.

### BRIEF SUMMARY OF THE INVENTION

One aspect of the subject invention utilizes the cohesive strength of a packing of colloidal polytetrafluoroethylene (PTFE) resin particles provided by the hydrostatic coalescible condition to from a thick coating. A coating of any desired thickness may be applied over a substrate or matrix of woven or non-woven material, such as glass fibers, without cracking upon drying or sintering. Coating thickness of prior art compositions is limited to less than 1 mil per coating application and preferably 0.2 mil per coat. The subject invention also relates to uniaxially-oriented extrudate and methods for processing the same utilizing colloidal size polytetrafluoroethylene resin particles.

Still another aspect of the subject invention relates to the advantage of uniaxially paste extruding colloidal size PTFE particles and particularly micron size fillers and additive up to 90% by volume. Previously, prior art uniaxial paste extrusion involving coagulated dispersion resin and fillers were unable to be processed above 5% and only 1% as a color marker. Functional amounts of the filler could not be processed successfully.

Another aspect of the subject invention relates to biaxially-oriented PTFE compositions made from uniaxially-oriented paste extrudate in the hydrostatic pressure coalescible state. In one embodiment, the composition is formed into a sheet. In one embodiment, the composition takes the form of a biaxially oriented tube. In yet another embodiment, the composition comprises one or more particulate materials such as fillers, additives, or a combination of both. The composition of the subject invention may also comprise a plurality of pores.

In another specific embodiment, the sheet is a porous membrane structure. In another embodiment, the porosity is asymmetric. In another embodiment, up to about 90% of the structure is porous.

The subject invention also relates to methods for preparing porous biaxially-oriented PFTE compositions utilizing fugitive pore-forming materials and methods for forming shapes from the PTFE composition of the subject invention.

Yet another aspect of the subject invention pertains to apparatus utilized in chemical processes that are lined with the biaxially oriented PTFE composition of the subject invention.

The methods of the subject invention provide significant improvements over an old uniaxially-oriented art form for manufacturing tubing, tape, film or similar shapes taught in U.S. Pat. No. 2,752,637. Advantageously, this invention utilizes existing equipment to produce a uniaxially-oriented pressure coalescible extrudate from which biaxially-oriented sheet and shapes may be fabricated with qualities similar to the materials disclosed in U.S. Pat. No. 3,556,161. The subject matter discussed herein can be extremely useful for fabricating many items. One advantage of the present invention over the aforementioned '161 patent is the elimination of multiple re-orienting steps, which entails more handling time and equipment. Consequently, the biaxially-orientated sheet only requires a single step of re-orientation, and in specific embodiments, the single step of re-orientation may be rolling, calendering, blowing, or re-extrusion.

Important changes in the traditional resin preparation procedure of the art process contained in the subject invention significantly improves extrusion performance and surprisingly makes it possible to successfully extrude filled compositions, heretofore thought to be impossible. Art process paste extrusion limits the amount of filling to very low percentages, up to 5 percent, which is adequate as a marker but is not physically functional and not generally used above one (1) percent without interfering with product quality. Filling by the process of this invention can be achieved beneficially up to about 90 percent by volume, depending upon the characteristics of the fillers or additives.

Advantageously, the biaxial planar oriented compositions of the subject invention can be used to line chemical vessels, piping systems, and apparatus surfaces to limit corrosion of the underlying material. The biaxial planar orientation of a sheet of the subject composition provides dimensional and form stability in the x-y dimension of the sheet. Moreover, the molecular ordering of the sheet provides a barrier to permeation of liquids and gases because of the close packing and orientation of the molecular chains.

The above and other aspects, features and advantages of the subject invention should become even more readily apparent to those skilled in the art upon a reading of the following detailed description of the embodiments of the subject invention.

### DETAILED DISCLOSURE OF THE INVENTION

One aspect of the subject invention is directed to uniaxially-oriented PTFE filled paste extrudates and methods for producing the same. A uniaxial filled PTFE extrudate is useful for, among other things, wire coverings, film employed as a wrap for bundling or for isolating bundles of wire, wrap for heavy transformer electrical wire insulation, specialty gaskets, and sealing applications. Advantageously, the extrudates may include up to about 90% by volume of particulate materials. The preparation of the resin and/or feed components prior to extrusion is one of the novel aspects of the methods of manufacturing uniaxially-oriented PTFE extrudate in accordance with the subject invention.

The methods of preparing the uniaxial paste extrudates of the subject invention include freeing PTFE colloidal particles from the PTFE coagulation particle aggregate by applying a liquid shearing force to the aggregate in a wetting liquid. The temperature of the wetting liquid is generally maintained at ambient temperature (that is, about 19° C. to about 23° C.). The wetting liquid is a liquid other than water that has a surface tension below 30 dynes/cm that readily wets and spreads on all fluoropolymer surfaces and is defined as a liquid whose contact angle is as near zero as possible when in contact with a fluoropolymer surface. A wetting liquid is most easily identified by the surface tension of the liquid. Exemplary wetting liquids include kerosene or ISOPAR H (isoparaffin manufactured by ExxonMobil Chemical, Houston, Tex.). In a contemplated embodiment, the wetting liquid is ISOPAR H (isoparaffin manufactured by ExxonMobil Chemical, Houston, Tex.), a hydrocarbon.

Once the wetting liquid penetrates the aggregate skin, it passes freely between the colloidal size particles by capillarity to lubricate the surfaces of each colloidal particle. Consequently, each colloidal particle is able to move freely and substantially independently from one another. Breaking open the aggregate size particle skin, wherein the average size of each particle is about 500 microns, releases the colloidal size particles and permits the free movement of these colloidal size particles, which are micron and submicron in size. The released colloidal particles may be from about 0.05 microns to about 5 microns. The smaller size of the released colloidal particles allows a more homogenous and intimate movement of particles and especially permits the incorporation of micron and sub-micron size particulate materials previously prohibited by large 500 micron aggregates of the typical prior art processes.

In a preferred embodiment, the colloidal freeing step comprises adding about one (1) part of coagulated dispersion PTFE resin to about 20 parts of a wetting liquid, preferably ISOPAR H, wherein the temperature of the wetting liquid is at about ambient temperature (about 20° C. to about 23° C.). The mixture is stirred for a sufficient period of time to release the colloidal particles and reduce the average particle size of the aggregate to about 10 microns. Preferably, the tip speed is about 2000 feet per minute, and the mixture is stirred for about one minute but not more than five minutes.

In another embodiment, the wetting liquid also contains at least one type of particulate material. The particulate material can be added to the wetting liquid before the PTFE coagulation particle aggregate and stirred for a sufficient amount of time, preferably about 15 seconds, to disperse the particulate material throughout the wetting liquid. Following the dispersal of the at least one particulate material throughout the wetting liquid, the PTFE coagulation particle aggregate is added and subjected to an application of liquid shearing force. A sufficient amount of particulate material is added to the wetting liquid so that the extrudate comprises up to about 90% by volume of particulate materials. In a contemplated embodiment, the extrudate may comprise at least about 2% by volume of particulate materials. Other suitable volumes of particulate materials include from about 2% to about 85%, from about 10% to about 70%, from about 30% to about 50%, from about 25% to about 75%, or from about 35% to about 45%. Other suitable percentages of particulate materials in the extrudates disclosed herein include from about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, or about 89% by volume.

In yet another embodiment, the particulate material is added to the wetting liquid simultaneously with the PTFE coagulation particle aggregate. In a third embodiment, the PTFE coagulation particle aggregate is added to the wetting liquid first and subjected to the application of liquid shearing force before the addition of the at least one particulate material.

Regardless of the order of addition of the particulate material and the PTFE coagulation particle aggregate, the resulting solids mixture that has been subjected to a shearing force is then poured into a vacuum filtering device, and the liquid phase removed until about 17% to about 20% of wetting liquid remains with the solids, and a filter cake is thereby produced. In a further embodiment, the percentage of wetting liquid in the filter cake may be about 17%, about 18%, about 19%, or about 20%. The filter cake preferably is protected from air leakage and/or uneven liquid distribution by, for example, covering the filter cake with a sheet of rubber sheet and pressing. The filter cake is loaded into the extruder barrel for extrusion. Preferably, the filter cake component is compressed slowly before extrusion begins to allow entrapped air to escape and the solids to consolidate. After the extruder is loaded, the extrusion proceeds as a normal art extrusion would, thereby producing a uniaxial oriented, hydrostatic coalescible extrudate. Paste extrusion plug flow is accomplished if flow in the extrusion barrel and die are streamlined, thereby eliminating or inhibiting turbulence and mixing.

Applying the deposited colloidal composition directly from the filtering step or acting as the filtering surface a crack free thick coating may be applied to woven fabrics, for food conveyor belting, separator sheets for laminating or press blankets requiring a high quality finish, printed circuit boards and surface coatings for substrates. The coating may be applied onto a woven or non-woven matrix or heat resistant base and/or electively compressed to consolidate the resin into the matrix or onto a surface.

Prior art coatings must be applied in a multiple coating process limited to less than 1 mil per coat and down to 0.2 mil to prevent the PTFE from cracking (termed ‘Critical Cracking Thickness”). Prior Art processing requires the coating to be dried at 120° C. (250° F.) to remove water then baked at 290° C. (550° F.) to remove wetting agent and finally applying heat above the crystalline melting point at 337° C. (639° F.) to sinter. Electively the coating composite may also be calendered to consolidate the composite prior to the sintering step.

It is interesting to note that the same cohesive forces that pulled colloidal particles together in this invention are the very same forces that have been forcing colloidal particles apart in water dispersion coatings and limiting coating thickness to very thin films if water dispersions are employed. To obtain the best quality, coating layers should be restricted to 0.2 micron per layer. That is the average size of the colloidal particle in a PTFE dispersion.

The void volume in the average packing is in the 17 to 20 percent range, which is the pore volume required to fulfill the hydrostatic coalescible state.

The amount of dispersing agent added to a dispersion is far below that range. One company adds 6% or less. After drying to remove water there is insufficient liquid to fulfill the wetting requirement. Once free of water the nonionic dispersing agent must be baked off before sintering is performed. Water applied coatings crack while cohesive coating prepared with sufficient true wetting solvents are not limited in thickness and do not crack.

The uniaxial orientated extrudates of the subject invention are useful as coatings on a substrate where no internal stress is exerted. For example, the extrudate can be used to cover a wire or woven fabric and may include fillers that prevent abrasion, cut-through, and reduce friction and wear. The extrudate may also be used as film employed as a wrap for bundling and isolation of wire bundles, wrap for heavy transformer electrical wire insulation, to reduce friction and wear, and to provide heat resistance and isolation of parts. The extrudate may also be utilized as the standard profile extrusions for specialty gaskets and sealing applications or for parts under compression. The uniaxial orientated extrudate may also be a lubricated feed for biaxial paste extrusion of sheet and tubing.

In one embodiment, the uniaxially-oriented extrudate may be further processed into the biaxially oriented sheet of the subject invention by rolling in the transverse direction (that is, 90 degrees to the initial extrusion direction). The force required to roll the pressure-coalescible extrudate is very low; the weight of the roll alone should be sufficient weight to apply the needed force. The extrudate should be protected so that the lubricant remaining in the extrudate does not escape by evaporation. When the desired length is extruded, the tube is cut longitudinally in a straight line from one end to the other. The cut tube is then laid on a flat smooth surface. A smooth surface roll, at least 6 to 8 inches in diameter, is laid parallel to its length. A strip of metal (thickness spacer), preferably the thickness of the desired sheet and slightly longer than the expected sheet width, is laid at either end of the length of tubing to be rolled. Once the set-up is in place, the roll is placed over the cut tube directed 90 degrees to the extrusion direction. The extrudate is then rolled until limited in compression by the thickness of the metal spacer strips at its ends. In rolling, a rectangular shaped sheet will develop. When the stress produced by rolling is about equal to the stress imparted by paste extrusion, the physical properties in the longitudinal and transverse directions are essentially equal. The rectangular sheet, when dried and sintered, displays planar biaxial orientation.

In a similar fashion, sheet and tubing extruded uniaxially can be biaxially oriented by rolling the extrudate normal to the extrusion direction a sufficient number of times to balance the stresses introduced longitudinally employing the same procedure used for tubing. Also, sheet extrudate extruded uniaxially may be calendered or rolled normal to its extrusion direction to produce planar biaxially-oriented sheet. As long as the hydrostatic condition remains with the extrudate, it may be worked to adjust the orientation.

Laminant constructions can be made during the original tubing extrusion by hand rolling a strip of each desired composition from the filter cake in a uniaxial direction with enough force to consolidate and provide coherence to the composition. The resultant strip of each composition is wound around the extrusion mandrel in the desired position until the mandrel and wound layers fit snuggly into the extrusion barrel. Each wound layer may be made of a different composition. Since the flow during extrusion is plug type, the layers are in exactly the same order in the extrudate as in the wound lay-up.

Sections of the biaxially-oriented sheet prior to the removal of lubricant may be used to form shapes, which are stable and display little to no shrinkage in the length and width dimensions after sintering, although shrinkage may occur in the thickness.

To produce a laminated structure, at least two biaxially-oriented extrudates of sheet extrusions may be placed one over the other and pressed together. Optionally, application of heat below up to 300° C. facilitates in merging the at least two extrudates in forming the laminate (temperature dependent on the composition type). The resulting laminate is biaxial planar oriented.

The subject invention which employs primary colloidal PTFE particles can provide biaxial planar orientation simply and inexpensively. Melt extrusion would require expensive changes in the uniaxial melt extrusion process of the resin as well as expensive and wasteful tenter from stretching in the direction normal to extrusion. The quality of available compression molded sheet would not tolerate tenter frame processing and the resultant anisotropic sheet would not be form stable. Current molding technology is limited to batch processing.

Advantageously, introducing orientation to unsintered hydrostatic coalescible extrudate is much easier and more effective than attempting to biaxially orient sheet made from either melt processable or sintered compression moldable resin types. Additionally, the extrudate of the subject invention is heat stable.

Another aspect of the subject invention relates to biaxially planar oriented compositions comprising polytetrafluoroethylene. The polytetrafluoroethylene is present substantially and entirely as discrete pellicles spaced discontinuously apart and parallel to the plane of the structure. The molecular structure of the subject invention is biaxially planar oriented, and the tensile strength is about equal in all planar sheet directions. Moreover, the structure of the subject invention is lamellae free. Advantageously, the lack of lamellae in the structures of the subject invention provides a more homogeneous structure, allowing the uninhibited permeation of gases and liquid through the lining structure employed as a protective chemical vessels lining.

The lack of lamellae in the compositions of the subject invention is evident from the methods of preparing the sheet. Although previously disclosed methods of preparation of PTFE sheet relied upon multiple steps of orienting, the sheet of the subject invention is prepared from an initial paste extrusion followed by a single step of re-orienting. Consequently, layers of lamellae never develop in the compositions of the subject invention because the subject methods advantageously exclude the repeated re-orienting steps responsible for the lamellae.

The biaxial compositions of the subject invention optionally comprise at least one particulate material. Particulate materials contemplated herein include solids, fibers, platelets, porous particulates, nanoparticles, and the like. For example, particulate materials useful for incorporation into the PTFE structures of the subject invention include, without limitation, polymeric additives and inorganic fillers. The particulate materials are homogenously dispersed amongst the PTFE pellicles of the subject structure in one embodiment. The PTFE compositions of the subject invention can include large percentages of particulates because of the lack of lamellae. Advantageously, up to about 90% by volume of the PTFE compositions may comprise at least one particulate material. The filled PTFE compositions may include more than about 2% of at least one particulate material. Preferred ranges for the percentages of particulates in the subject compositions are about 0.1% to about 10%, about 10% to about 20%, about 20% to about 30%, about 30% to about 40%, about 40% to about 50%, about 50% to about 60%, about 60% to about 70%, about 70% to about 80%, and about 80% to about 90%. Other suitable percentages of particulate materials in the compositions disclosed herein include from about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, or about 89%.

Although it was previously disclosed that particulate materials can be trapped between the lamellae of PTFE resins (See U.S. Pat. No. 3,556,161), in the subject compositions the particulate materials surround each PTFE pellicle and are homogenously dispersed throughout the sheet of the subject invention. Since the PTFE compositions of the subject invention are prepared without multiple re-orienting steps, lamellae are not present; thus any particulate materials are not trapped within the composition.

Exemplary polymeric additives include, without limitation, particulate fluorocarbon resins that show adhesion to PTFE resins, polyether resins, and granular PTFE. In a specific embodiment, particulate fluorocarbon resins that show adhesion to PTFE resins are selected from the group consisting of perfluoroalkoxy tetraethylene copolymer resin (PFA), ethylenechlorotrifluoroethylene copolymer resin (E-CTFE), ethylenetetrafluorothylene copolymer resin (E-TFE), poly(vinylidine fluoride) resin (PVDF), tetrafluoroethylenehexafluoropropylene copolymer resin (FEP), and poly(chlorotrifluoroethylene) resin (CTFE), or a combination of any of the foregoing.

In yet another embodiment, a polyether resin is selected from the group consisting of polyether ether ketone resin (PEEK), polyether ketone resin (PEK), and polyethersulfone resin (PES), or a combination of any of the foregoing.

Granular PTFE may be added beneficially in amounts up to about 50% of the PTFE content. Granular PTFE may be added to the PTFE colloidal particles alone or in combination with other particulate materials. Advantageously, utilizing granular PTFE as a filler is economically feasible because granular PTFE is less expensive than the corresponding PTFE resins. Particulate modified granular forms may also be added, for example, TFM.

Preferred inorganic fillers include crystalline inorganic materials similar in chemical resistance to PTFE, metal powders, particulate materials that impart thermal or electrical conductivity, particulate fillers that control the friction and wear of PTFE articles, and fugitive particulates that advantageously provide a porous PTFE composition following their removal.

In one embodiment, the crystalline inorganic materials that are similar in chemical resistance to PTFE can be selected from at least one material selected from the group consisting of a nitride, a diboride, silicon carbinde, zirconium carbide, tungsten carbide, and boron carbide. If the filler is a metal powder, the metal powder may be selected from the group consisting of gold, silver, platinum, iron, aluminum, copper, bronze, and titanium, or a combination of any of the foregoing. Particulate materials useful for imparting thermal and electrical conductivity include, for example and without limitation, carbon, graphite, silicon carbide, gold, silver metal oxides, or combinations thereof. In yet another embodiment, particulate fillers that control the friction and wear of PTFE articles include, without limitation, silicon carbide, graphite, molybdenum, chopped glass fibers, and mica. In another embodiment, particulate fillers can be selected from mica, which is useful for improving electrical properties, carbon and graphite, which are electrical conductors, and ceramic oxide catalysts, which are useful as fuel cell catalysts.

Advantageously, in some embodiments, the PTFE biaxial orientated structures can include any material capable of withstanding the fusion temperature range of PTFE (about 342° C. to about 400° C.) which imparts a desired functional component to the structure with the exception of explosive materials such as thermit process components.

In a preferred embodiment, the particulate materials are less than about 25 microns in size. Particulate materials less than about 25 microns in size promote good homogenous mixing and avoid interference with the plug flow of the paste extrusion process. Additionally, particulates less than about 25 microns in size help to prevent cavitation and turbulence, which are detrimental to the paste extrusion process. In yet another embodiment, the particulates are extremely small, for example, in preparation of porous membrane structures and filters where the particulate size will determine the pore size after the particulates are extracted from the PTFE matrix. For example, the subject invention contemplates the incorporation of nano-sized materials into the PTFE sheet. For example, nanotubes, nanofibers, nanoparticles, and the like can be included in the PTFE sheet of the subject invention. Advantageously, as the size of the particulate materials becomes smaller, a smaller quantity of the particulate material is incorporated to achieve the desired effect.

In another embodiment, the filler particulates are larger than about 25 microns. Particulates larger than about 25 microns are advantageous when the particle imparts certain qualities, for example, improved thermal conductivity.

Another embodiment of the PTFE compositions of the subject invention is a porous, biaxially-oriented planar composition comprising a plurality of PTFE pellicles and up to about 90% by volume of pores. Pores are created by the removal of a fugitive material from the PTFE composition. As used herein, the term “pore” is interchangeable with the terms “porosity,” “void,” or “void space.” In one embodiment, particulate polymethylmethacrylate is the fugitive material. Particulate polymethylmethacrylate advantageously decomposes when heated above its melting point. In particulate form, it mixes with PTFE resin and, following the decomposition, leaves voids in the PTFE matrix replicating the size of each fugitive particle. As noted herein, up to about 90% of the volume of the PTFE compositions of the subject invention can be void space, or pores, left by the removal of fugitive particles like particulate polymethylmethacrylate. In one embodiment, the size of each fugitive material is uniform, thereby a porous PTFE composition having a plurality of uniform pores is prepared when the fugitive material is removed. In another embodiment, the fugitive material comprises more than one size of materials, thereby producing a composition with pores of various size. Exemplary fugitive particulates include sodium carbonate and calcium carbonate, which are both removable by chemicals like acid, sodium chloride, calcium chloride, and potassium chloride, which are removable by water, sodium tetraborate, which is removable by a combination of heat and leaching with water, and ammonium carbonate, methylmethacrylate, and polymethylmethacrylate, which are removable by sintering.

Other suitable percentages of porosity in the compositions disclosed herein include from about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, or about 90%.

Another aspect of the subject invention pertains to apparatus having an inner surface, wherein at least a portion of the inner surface is coated with a barrier lining comprising a PTFE composition of the subject invention. In one embodiment, the composition may be in a structure of a sheet. In one embodiment, the thickness of the barrier lining of the subject apparatus is at least about 0.09 inches. The thickness may be no more than about 0.6 inches in a further embodiment. In another embodiment, the thickness of the barrier lining is between about 0.125 inches and about 0.5 inches thick.

Yet another aspect of the subject invention comprises methods for re-shaping a PTFE composition of the subject invention. The methods comprise providing a PTFE composition of the subject invention and applying a force sufficiently strong to reshape the composition. The composition may initially be in a structure of a sheet. The composition may be reshaped into various structures by applying sufficient force. Different applying techniques include, but are not limited to, blowing, mold blowing, compressing, deep drawing, vacuuming, or extruding. The re-shaping may be facilitated by heating the PTFE sheet above ambient temperature. The sheet may be heated to the melting point of PTFE. In a contemplated embodiment, the sheet may be heated up to about 300° C.

The subject invention is unique in its flexibility. Physical properties are somewhat similar to U.S. Pat. No. 3,556,161; however, the subject invention's method of manufacture is significantly different and the resulting resin structure although similarly biaxially planar oriented is comprised physically of a different resin fine structure, which can importantly influence product performance in important functional aspects.

It is to be understood that the terminology used herein is for the purpose of describing particular embodiments only and is not intended to be limiting.

As used herein, polytetrafluoroethylene resin pellicle is a discrete submicroscopic film formed from a colloidal particle structure in the submicroscopic size and thickness range. The pellicle structure is comprised of fine domains of varying submicroscopic sizes and thicknesses dependent upon the size of the colloidal particle it was derived from. The film domains are comprised of PTFE resin, prepared in process from colloidal particles, which may range in size from 0.05 to 5.0 microns, which is the range of sizes that make up the 0.2 micron average size of the raw dispersion composition. Due to the extremely small size of the colloidal particle, pellicle thickness is significantly thinner than colloidal particle diameters due to processing. Because of their extremely small size pellicles cannot be observed visually or microscopically and are small enough and thin enough not to interfere with the homogeneity of a mix of microscopic size fillers and resins; a problem encountered with the lamellae of the '161 patent, wherein lamellae are clearly visible and are much thicker (10 microns) and generated and developed by a series of biaxial calendaring steps. Pellicle formation in the subject invention is the product of two single biaxial forming steps with no opportunity to build a lamellae structure.

Physically the polytetrafluoroethylene structure of the present invention is composed of independently spaced pellicles whose face lei parallel to the plane of the PTFE resin fine structure similar to the orientation of the lamellae in the '161 patent but since the pellicles of the instant invention do not touch to form lamellae (layers) they do not interfere with the removal of pore former additives (in the '161 patent process particles 20 microns or less become encapsulated (trapped) between lamellae layers). Moreover, the structure of the subject invention is lamellae free. Lamellae form distinct optically visible layers between each calendering pass that directly correlates with the number of calendaring passes require to biaxially calendar a sheet of quality product.

As used herein, the term “lamellae” refers to thin, continuous structures in the micron thickness range found in PTFE sheet produced by multiple re-orienting steps (See, for example, U.S. Pat. No. 3,556,161). Lamellae can be viewed microscopically in microtomed cross-sections. The term “lamellae” is interchangeable with “fault planes.” A sheet biaxially calendered 8 biaxial passes would produce 128 lamellae layers; 12 passes would produce 2048 lamellae layers.

As used herein, the term “laminations” refers to layers of sheet composition in the mil thickness range and above. Lamination may be viewed visually.

As used herein, the term “calendering” when used for biaxial orientation refers to passing the same material between two uniform clearances, rolls 8 to 12 times with each pass, even speed rolls rotating at a preferable surface speed of about 2 feet per minute. The doubled thickness of the processed material is reduced by approximately 50% with each pass through the calender at 90 degrees to the previous pass to produce shear, thus introducing biaxial orientation.

As used herein, the term “calendering” when used for compacting refers to a single pass through a calender for compaction only and to laminate layers of a composite consisting of two or more layers. Shear and working of the resin is not the objective; thus, orientation should not occur.

As used herein, the term “rolling” refers to results that are equivalent to calendering, the choice is a matter of preference to accomplish a particular operation. Rolling is performed on a flat level surface. Accurate sheet caliper is more difficult to maintain than with calendering. Two spacers at both ends of the roll control thickness. When performed in identical sequence, rolling and calendering have proved to be equal.

As used herein, the term “filler” refers to material added to extend the ability and reduce the cost of a polymeric material. The ordinarily skilled artisan can select fillers having functional advantages such as reducing deformation, reducing cold flow, controlling friction, or improving thermal and electrical properties of the polymer,

As used herein, the term “additives” refers to special function materials, for example, additives that add color, or to improve adhesion, to foster nucleation and so forth.

As used herein, the term “hydrostatic pressure coalescible composition” refers to a homogeneous packing of polytetrafluoroethylene (PTFE) colloidal resin particles, which may or may not contain submicron particulate solids up to 25 microns in size, in a liquid that wets all surfaces of the PTFE and solids, the liquid component maintaining a volume percentage between 17 and 20 percent of the mix in compressed void free form. Capillarity and Van der Waals forces provide the cohesive force that holds the preform together. The condition is dependent upon the particle packing of the total solids component. Below 17% there is insufficient liquid to fill voids between packed particle, thus promoting cavitation. Above 20% there is an overabundance of liquid to fill the packing void, which promotes turbulence. In the 17 to 20 percent liquid zone, capillary and Van der Waal forces in the spaces between packed particles develop energy to draw the packed particles together. The resulting cohesion of particles is responsible for the surprising strength developed before a biaxial PTFE matrix is developed to further aid the development of strength.

As used herein, the term “paste extrusion” refers to extrusion of a hydrostatic pressure coalescible composition that is preformed at room temperature; the colloidal PTFE resin component has never been melted. The extrusion mold and its die components are streamlined to prevent cavitation and turbulence. This form of extrusion involves plug flow; the flow is uniaxial, or biaxial planar (also radial in special forming operations). Since the flow is plug flow, particles move together and no mixing occurs. For example, a tube in the extruder barrel remains a tube when extruded but has a much smaller diameter and a thinner wall. Coagulated dispersion resin, often called fine powder, is actually a loosely aggregated particle whose average size is 500 micron, which is far from a fine powder, the large particle size of the aggregate limits filling to covering the outer aggregate surface leaving an excess of filler and minimum of PTFE surface area per weight of resin to absorb the excess filler.

As used herein, the term “particle size” refers to the average diameter of a spherical particulate matter or the equivalent diameter size of a non-spherical particulate matter added to the PTFE sheet of the subject invention. Particle size in paste extrusion is important, but not critical, to the extrusion process if the particle size remains in the recommended size range, preferably up to and including 25 microns as described in this invention. Sizes above 25 microns can be employed in certain applications but rarely larger than 50 microns. For pore forming applications, the desired fugitive particle size is generally below 10 microns and for special microfiltration applications particle size below 1 micron are desirable.

As used herein, the term “matrix tensile strength” refers to the tensile strength based on the total cross-section, corrected for the percentage of voids in the structure employed for determining the tensile strength of porous compositions of PTFE.

As used herein, the term “lubricant” refers to the wetting liquid employed in paste extrusion.

As used herein, the term “fish-tail die” refers to a stream-lined die shaped like a fish tail employed for paste extruding tape and film.

As used herein, the term “wetting liquid” refers to a liquid with a surface tension of less than 30 dynes/cm that will spread and permeate all PTFE surfaces on contact and is sometimes referred to in paste extrusion as a lubricant. Since water does not spread or wet a PTFE surface (water beads on PTFE surfaces and has a contact angle of 1080 and it has a surface tension of 72.8 dynes/cm at 25° C.), water is excluded as a wetting liquid. A preferred wetting liquid, ISOPAR H (isoparaffin manufactured by ExxonMobil Chemical, Houston, Tex.) is an isoparaffinic liquid that has a contact angle of 0° and a surface tension of 24.9 dynes/cm at 25° C. As used herein, ISOPAR H is used as a wetting and neutralizing liquid to permit uninhibited mixing of particulate materials with PTFE resin. Advantageously, the preferred wetting liquid, ISOPAR H, provides inherent purity, low heat of vaporization for fast evaporation, low odor, high auto-ignition temperature and compliance with Food and Drug Administration (FDA) requirements for food and skin contact.

All patents, patent applications, provisional applications, and publications referred to or cited herein are incorporated by reference in their entirety, including all figures and tables, to the extent they are not inconsistent with the explicit teachings of this specification.

Following are examples that illustrate procedures for practicing the invention. These examples should not be construed as limiting. All percentages are by weight, and all solvent mixture proportions are by volume unless otherwise noted.

### EXAMPLE I

This example demonstrates the art method of preparing coagulated dispersion resin for paste extrusion and its effect on the quality of the finished product.

18% of a wetting lubricant is added to the charge of polytetrafluoroethylene coagulated dispersion resin required to fill the extrusion barrel. In addition, 1% carbon black is added to the lubricant as a marker to coat the surface of each coagulated dispersion particle. These ingredients are gently tumbled at ambient temperature for about 1 hour and then allowed to stand 4 to 6 hours before charging to the extruder barrel. The lubricated resin is added uniformly to the extrusion barrel and low pressure is applied at a slow rate of compaction to allow entrapped air to escape and to consolidate the charge. The extrusion is initiated and processed in the usual fashion; the extrudate is dried and finally sintered. Microscopic examination of microtomed sections of longitudinal and transverse lengths reveals a carbon black outline of each coagulated dispersion particle domain. The longitudinal section reveals elongated lancet shaped domain areas while the transverse domains are elliptical to essentially round.

Electron microscope observations of a fractured unsintered extrudate show the dispersion particles as discrete, essentially round particles, within a carbon black envelope, with no dispersion particle distortion.

It is obvious that there is no intermixing of particulate matter and not surprising that fillers and additives cannot mix readily and intimately in a composition made by this process.

### EXAMPLE II

This example demonstrates the special features of this invention that make filling and other polymeric additions possible and exceptional, as well as extrusions more homogenous to assist the plug flow rheology of this system. As a part of this example, one part of coagulated dispersion resin is added to 20 parts of lubricant, such as ISOPAR H (isoparaffin manufactured by ExxonMobil Chemical, Houston, Tex.), containing 1 percent of carbon black as a marker. The mixture is sheared by a stirrer with a tip speed of 2000 feet per minute for 1 minute at ambient temperature. The sheared mixture is then poured into a vacuum filter to remove excess liquid. A sheet of thin rubber is then placed over the filter and pressed into the filter cake to prevent air from passing around the filter cake edges, which also helps to maintain a uniform lubricant level within the filter cake. When 18% of the liquid remains, the cake is removed and charged to the extruder barrel and the extrusion completed as in Example I.

Microscopic examination of the sintered extrudate, as in Example I, shows a homogenous mix of filler particles with the colloidal PTFE particles uniformly dispersed. It is difficult to ascertain any area domains free of filler such as seen in Example I.

### EXAMPLE III

This example demonstrates that filled laminate can readily be extruded in tubing form. Three filter cakes of filled compositions containing 30 percent mica, 25 percent graphite and 100 percent PTFE were prepared according to the procedure of Example II. To gain handling strength, each cake is rolled uniaxially to elongate the cake to form a strip that can be wound around the extrusion mandrel. Each strip of rolled filter cake containing fillers is wrapped in the order desired until the mandrel plus multiple wraps will fit snuggly inside the barrel of the extruder. The triple layered lay up is then extruded, dried and sintered. Microtomed cross sections of the tubing reveal a multi layered laminate of mica, PTFE and graphite. A similar extrusion of fiberglass, PTFE and graphite was also processed. There is excellent adhesion between layers even after flexing. The composite composition is homogenous. The laminate layers appear in the same order as wrapped around the mandrel.

### EXAMPLE IV

This example demonstrates the transformation of uniaxially-oriented hydrostatic coalescible extrudate to planar biaxial oriented tubing utilizing the resin preparation procedure described in Example II.

A 4-inch length of hydrostatic coalescible tubing extrudate ⅞-inch diameter is cut for transverse rolling. A twelve-inch long rod, slightly smaller than the extrudate I.D., is inserted through the tube. Spacer shims are placed at either end of the tube to limit the rolling compression and to define the sheet thickness. In this example, three separate lengths of tubing extrudate were rolled to increase their diameters. Table I shows the tensile strength properties of the control and three rolled tubing lengths after drying and sintering. The tensile properties of the longitudinal and transverse tensile section are essentially equal when the longitudinal stress imparted by extrusion equals the stress introduced by transverse rolling. The sheet becomes biaxially-oriented, and the longitudinal and transverse tensile strengths are essentially equal and greater than 5,000 psi. The marked increase in transverse tubing strength can be a significant improvement where burst strength is critical. The principal stress in hydraulic hose under pressure is in the hoop direction where biaxial orientation is a distinct advantage over uniaxial orientation where transverse tensile properties are significantly less.

TABLE I
PROPERTIES OF Biaxially-oriented TUBING
(As Produced by Hand Rolling Extrudate)

| | | Diameter | | | | | |
|---|---|---|---|---|---|---|---|
| | | LONGITUDINAL* | | | TRANSVERSE* | | |
| Inches | | Tensile | Yield | | Tensile | Yield | |
| (Uninserted | Sample | Strength | Stress | Elongation | Strength | Stress | Elongation |
| Tubing) | No. | psi | psi | % | psi | psi | % |
| 0.88 | 4 | 4500 | | 350 | 3200 | 1690 | 350 |
| Control | | | | | | | |
| 1.27 | 1 | 3690 | 1870 | 360 | 5010 | — | 380 |
| Hand Rolled | | | | | | | |
| 1.91 | 2 | 4720 | 1880 | 440 | 5120 | — | 350 |
| Hand Rolled | | | | | | | |
| 4.14 | 3 | 5700 | 2070 | 500 | 5850 | — | 420 |
| Hand Rolled | | | | | | | |
| Property | | 26% | | 30% | 83% | | 20% |
| Improvement | | | | | | | |
| Sample 4 to 3 | | | | | | | |

NOTE:
Tensile properties after sintering at 380 degrees Centigrade
*Tensile Direction

### EXAMPLE V

This example demonstrates methods for fabricating planar biaxially-oriented sheet, both filled and unfilled. The process described in Example II is employed to prepare the resin for extrusion. Very simply large diameter hydrostatic coalescible tubing extrudate is fabricated with or without fillers and additives. Instead of rolling the extrudate as tubing, the extrudate is slit longitudinally and rolled as a sheet similar to the procedure in Example IV. The resulting product of this example is essentially equal to that of Example IV.

### EXAMPLE VI

This example demonstrates the most direct method of making biaxially-oriented sheet, either filled or unfilled, by the resin preparation method of Example II extruded directly as uniaxial oriented sheet followed by rolling or calendering the hydrostatic coalescible extrudate in the transverse direction until stresses are equal in all directions. The dried and sintered product displays biaxial orientation with physical properties equal in both longitudinal and transverse directions.

### EXAMPLE VII

The hydrostatic coalescible biaxially-oriented sheet produced by any of the processes of this invention may be used as the starting material for forming a variety of shapes by simple compression, deep draw, vacuum, blowing or other suitable forming techniques.

### EXAMPLE VIII

This example demonstrates the subject invention's versatile use in manufacturing porous and asymmetric porous structures, including membranes for use in a wide variety of applications such as: filtration, matrix for catalyst support, fuel cell components and electronic components. The pore-forming ingredient for this application is a fugitive particulate filler material that can be removed by leaching, chemical reaction or thermal decomposition during PTFE sintering. The pore former particle size determines the pore size of the pore structure. The pore former and filler, if one or more is desired, is added first to the wetting liquid in the process described in Example II. The preferred amount of PTFE resin included is 20 percent by volume based on the solids amount added, which is sufficient to provide a strong biaxial matrix for the finished biaxial oriented matrix of the porous structure. The process of Example II is followed and the mixture is then processed according to Example V if a tubular form is desired. In order to produce sheet, the procedure of Example VI is followed. After the pressure coalescible structure is complete, the structure is dried and sintered at 380 degrees Centigrade. After sintering, the filler is removed from the structure. If the fugitive filler is sodium chloride, water is used. However, if the fugitive filler is calcium carbonate, dilute hydrochloric acid is used and finally washed clean with water. Ammonium chloride, ammonium carbonate and polymethylmethacrylate all will decompose during the sintering process. Membranes made by this invention have a calculated tensile strength of 5,000 psi when the percentage of PTFE is considered (that is, the 20 percent PTFE matrix will have a tensile strength of 5,000 psi).

### EXAMPLE IX

This example is to demonstrate the use of this invention to produce asymmetric filters with controlled pore size in a laminate structure to provide improved filtering performance in the removal of particulate material. A porous structure is prepared according to Example VIII wherein only three different pore size compositions are prepared: one containing a fugitive pore former with an average particle size of 10 microns, one with 5 micron particle size and one with 1 micron particle size. The three hydrostatic coalescible compositions are processed according to procedure described in Example III while the extrudate is processed according to the process of Example V to produce a tube which is then dried and sintered. Finally, the fugitive pore former is removed as described in Example VIII.

Microtomed cross sections of the tubing reveal three distinct porous layers with their respective pore size essentially equal to the pore former particle size added to each composition.

### EXAMPLE X

This example demonstrates making an asymmetric filter with controlled pore size by preparing two or more compositions containing calcium carbonate of different particle size according to Example II and then processing the hydrostatic coalescible extrudate of each separately by Example VI. While still in the hydrostatic coalescible state, each composition is plied and pressed together at pressure of 1,000-psi. Heat may be applied up to 300 degrees Centigrade. The laminate is dried till free of lubricant and then sintered by infrared or oven at a temperature of 380 degrees Centigrade for 15 to 20 minutes. The calcium chloride is removed by diluted hydrochloric acid and washed until free of acid.

Microtomed cross sections reveal porosities that replicate the size of the particles added as filler to each laminant layer.

### EXAMPLE XI

This example demonstrates forming by compression by employing a matched mold. The part is comprised of a dish with flat bottom, tapered sides, flat lip and wall cavity of 0.040 inch when closed. The biaxially-oriented pressure coalescible material to be reshaped is a sheet made by the procedure described in Example VI. A circular section of this sheet is clamped around the top circumference of the mold to ensure that draw down into the mold will be uniform. The compression rate for draw down is very slow to allow the wetting lubricant and air to escape, especially during the final steps of compression. The temperature for all operations should be above 30 degrees Centigrade. Once the part has been formed, the temperature of the mold may be raised gradually to as high as 300 degrees Centigrade to assist removal of lubricant. Alternate periods of heat and compression will also help the lubricant to escape. In addition, partial removal of the male die will also facilitate lubricant evaporation. When the part is essentially lubricant free, it may be removed from the mold for more complete drying at temperatures up to 300 degrees Centigrade. Once completely dry, the part should be returned to the heated mold and compressed to consolidate the part and eliminate any incidental voids that remain. The formed part is then free sintered at 380 degrees Centigrade for 10 to 15 minutes. The part is form stable and has a good appearance. A porous metal die or weep holes placed in strategic locations might solve many of the lubricant removal problems encountered.

### EXAMPLE XII

This example employs the same mold pair as Example XI, but the hydrostatic pressure-coalescible material for feedstock is cut into 4-inch discs, which are stacked snuggly into the bottom mold to a thickness of 0.270 inch. When pressure is applied, the discs will extrude upward, expanding circumferentially to fill the mold cavity. Sufficient material was provided to allow for a small amount to extrude at the top flange.

After the part was formed, the mold was heated to expel lubricant and to dry the formed shape. When essentially dry, the molded part was removed from the mold and heated up to 300 degrees Centigrade to remove the last traces of lubricant. When completely dry, the part was placed back into the mold and compressed to eliminate possible voids and to further consolidate the molding. The part was removed from the mold and free sintered at 360 degrees Centigrade for 10 to 15 minutes. Table II provides shrinkage data for the bottom, wall and top (flat lip) of several of the parts formed, as well as the compositions of all parts formed. It is surprising that parts are all form stable after free sintering.

TABLE II

| | | | **Total Shrinkage % | | |
|---|---|---|---|---|---|
| Sample | | *Lubricant % | Bottom | Wall | Top |
| Composition | | Feed Stock | A | B | C |
| 1. | TEFLON 6 | 18 | 22 | 14 | 13 |
| 2. | 30% Mica | 18 | 10.5 | 3 | 5 |
| | 70% TEFLON 6 | | | | |
| 3. | 30% Bronze | 18.5 | 10.5 | 8.5 | 2 |
| | 70% TEFLON 6 | | | | |
| 4. | 25% Fliberglas | 17 | 12 | 6 | 6 |
| | 75% TEFLON 6 | | | | |
| 5. | 30% Bronze | | 10.5 | 8.5 | 6.5 |
| | 70% TEFLON 6 | | | | |
| | 10 mils (outside)*** | | | | |
| | TEFLON 6 | | | | |
| | 30 mils (inside)*** | | 12 | 6 | 6.5 |
| 6. | 30% Bronze | | | | |
| | 70% TEFLON 6 | | | | |
| | 30 mils (outside)*** | | | | |
| | TEFLON 6 | | | | |
| | 10 mils (inside)*** | | | | |

*Weight percentage in feedstock.
**Total percentage of shrinkage for each dimension based on the original mold dimension.
***Wall thickness of all parts is 40 mils.

The compositions evaluated in the table were chosen to represent different particulate forms and lamination schemes as shown below.

Sample 1 is unfilled TEFLON 6 shrinkages were always greater without fillers.

Sample 2 contains 30 percent Mica (platelets).

Sample 3 contains 30 percent Bronze (particulate).

Sample 4 contains 25 percent Fiberglas (chopped fibers).

Sample 5 contains a 10 mil outer layer of 30 percent Bronze and 70 percent TEFLON 6 and an inner layer 30 mils thick of TEFLON 6 (lamination).

Sample 6 contains a 30 mil outer layer of 30 percent Bronze, 70 percent TEFLON 6 and an inner layer 10 mils thick of TEFLON 6 (lamination).

The data show higher shrinkage when fillers are not included. Compositions containing either fibers or platelets show lower shrinkage. In addition to the above compositions “parts” were successfully formed containing 25 to 30 percent of mica, fiberglass and graphite and laminated combinations of each, however, shrinkage data is not available. All parts formed were form stable with an excellent appearance and a smooth homogenous texture.

With the available equipment, Example XII was preferred because the results were more reproducible.

### EXAMPLE XIII

This example demonstrates the fabrication of a shaft seal post-formed from two hydrostatic pressure coalescible sheet compositions produced according to Example VI. Discs 1.12-inch diameters, 0.04 inch thick, were die cut from the above sheet. Two compositions were evaluated: one unfilled TEFLON 6 and one containing 25 percent Beta Fiberglas and 75 percent TEFLON 6. A hole 0.175 inch in diameter was die cut from the center of each of 5 discs; one set was prepared for each composition.

The die cut discs were held firmly around the outer perimeter while a tapered mandrel was passed through the center of each hole until the full diameter of the tool, 0.625 inch, passed through each to flare and form the lip seal.

The formed seal was dried in a circulating air oven at 150 to 200 degrees Centigrade for 15 to 20 minutes and then free sintered at 360 degrees Centigrade for 10 minutes. Shaft seals were form stable and displayed a smooth homogeneous texture. Table III shows the shrinkage by dimension after free sintering.

TABLE III
Shaft SEAL Shrinkage after Sintering

| | TEFLON 6 | 25 Percent Fiberglas |
|---|---|---|
| Height | 20 +/− 4% | 8 +/− 4% |
| O.D. | 16 +/− 3% | 8 +/− 4% |
| Thickness | 16 +/− 2% | 8 +/− 4% |

Note:
Data above are based on five samples of each composition
*Shrinkages are determined from wet die cut rings and compared to the finished sintered part. The tooling size employed in this example is shown in Table IV of Example XIV under Step No. 5.

### EXAMPLE XIV

This example demonstrates forming of shaft seals made from biaxially-oriented sintered sheet. Shaft seals were made by the art process and were formed from unfilled sintered skived (shaved) sheet. Tooling is similar to that described in the last example. Rings were die cut with 1.12 inch O.D. and a hole corresponding to the sizes shown in the Table ranging from 0.362 to 0.175 inch. The art process sheet stock was skived from a billet made from quality granular PTFE. A corresponding set of rings was prepared from sintered sheet containing 30 percent graphite (Acheson GP 38) and 70 percent TEFLON 6 prepared according to the process of Example VI. Shaft seals were formed as in the last example for comparison. Shaft seals could not be formed beyond step No. 3 when formed from skived art processed sheet without tearing and cracking. Shaft seals made by the process of this invention could easily be formed to and including step No. 5. Even after step No. 5, forming the die cut lip remained smooth and there were no signs of cracks forming. Table IV lists dimensional changes due to forming.

TABLE IV
Shaft Seal Forming Tool Parameters

| Step | Forming Shaft | Original Center | *Circumference |
|---|---|---|---|
| No. | O.D. Inch | Hole Diameter | Enlargement, % |
| 1 | 0.625 | 0.362 | 73 |
| 2 | 0.625 | 0.314 | 99 |
| 3 | 0.625 | 0.272 | 129 |
| 4 | 0.625 | 0.223 | 180 |
| 5 | 0.625 | 0.175 | 257 |

*Percentage enlargement due to circumferential stretching by the forming tool.

The quality of the sintered biaxially-oriented graphite filled shaft seals was superior to the shaft seals formed from the art skived unfilled sheet, demonstrating that filler and reinforcements may be added by this invention without any loss of quality. Excellent shaft seals were fabricated from other sheet compositions made according to the process of this invention.

### EXAMPLE XV

This example demonstrates the forming of complex shapes that do not require deep draw. For this example, a 8-inch diameter diaphragm is formed in matching die halves to form a 0.060-inch thick part with three concentric ribs approximately one inch deep. Hydrostatic coalescible biaxially-oriented sheet made according to Example VI is the stock for this example. A disc of the stock is placed in the mold and compressed slowly with a final dwell time of about one minute, longer for the thicker parts, with adequate time for lubricant to escape. The part is removed from the die and dried until free of lubricant and then free sintered at 360 to 380 degrees Centigrade for no longer than 15 minutes. The finished part is form stable and biaxially-oriented. Parts were formed from both filled and unfilled stock. All parts formed replicated the mold detail well and were of excellent quality.

Parts were also molded successfully from feedstock dried and free of lubricant. For these experiments, the mold was heated up to 300 degrees Centigrade to facilitate processing as heat has a plasticizing effect on the resin. However, the temperature should never exceed 300 degrees Centigrade until all molding and forming has been completed.

### EXAMPLE XVI

This example demonstrates the expansion of tubular pressure coalescible extrudate by blowing to impart biaxial orientation. The tubing is processed according to Example V. However, the tubing is not expanded by rolling, as in Example V, but rather by air pressure applied to the I.D. of the length of extrudate. To assist in the control of the blowing process, a length of expandable rubber tubing is placed inside the pressure coalescible tube, plugged at one end to contain the air. At the opposite end of the tube, air is fed in at a controlled moderate rate to expand the extrudate into a larger diameter tube to limit the expansion and to determine the final expanded dimension of the biaxially formed tube. Once the expansion is completed, the air pressure is maintained and the formed biaxial tube dried, the rubber tube is removed and the tube is sintered at 360 to 380 degrees Centigrade for no longer than 15 minutes. The starting O.D. diameter of the extrudate was 0.88 inch after expansion by blowing, drying and sintering the O.D. diameter was 4.00 inches. The resulting product was biaxially-oriented, since the tensile strength in both the longitudinal and transverse directions is equal and greater than 5,000 psi.

### EXAMPLE XVII

This example demonstrates the ability of a biaxially-oriented tube to become heat shrinkable and to restore the memory phenomenon fluoropolymers have become noted for. Once the molecular structure is sintered (fused), the molecules become interconnected and can no longer act independently as in the hydrostatic coalescible state where molecules are free to slide around freely without memory. In the interconnecting locked state memory is restored if stretching occurs.

In this example, lengths of biaxially-oriented sintered tubing made according to Example V and Example XVI are expanded by commercial art methods and then frozen as expanded only to be shrunk later when heated to or above that expansion temperature. Expansion and recovery were demonstrated successfully with both filled and unfilled tubing compositions. Heat shrinkable filled fluoropolymer compositions are not available in any resin form. Selected fillers might have added functionality, such as silicon carbide for abrasion resistance, carbon or graphite for static dissipation, and polymeric additives for property improvement.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification.

### REFERENCES

U.S. Pat. No. 3,003,912
U.S. Pat. No. 3,010,950
U.S. Pat. No. 3,556,161
U.S. Pat. No. 2,752,637

I claim:

1. A biaxially planar oriented structure comprising independent disconnected polytetrafluoroethylene resin pellicles of submicroscopic size molecularly oriented such that when stressed the longitudinal and transverse strengths of the planar structure is essentially equal.

2. The biaxially planar oriented structure according to claim 1, further comprising a plurality of at least one particulate material, and wherein the particulate material is dispersed homogeneously throughout the structure, wherein the particulate matter comprises between about 0. 1% to 90% by volume of the structure.

3. The biaxially planar oriented structure according to claim 1, wherein said structure is in the form of a tube or sheet.

4. The biaxially planar oriented structure according to claim 1, optionally comprising said at least one particulate material as described in claim 2, wherein said biaxially planar oriented structure is employed as a roll covering for process rolls in the paper and textile industry or the like or for non-stick purposes and wherein said biaxially planar oriented structure comprises fillers added to control friction, wear and conductivity.

5. The biaxially planar oriented structure according to claim 2, wherein the at least one particulate material is a polymeric additive and/or inorganic filler.

6. The biaxially planar oriented structure according to claim 2, wherein the at least one particulate material is a polymeric additive capable of adhering to polytetrafluoroethylene resin.

7. The biaxially planar oriented structure according to claim 5, wherein the polymeric additive is a particulate fluorocarbon polymer resin, wherein said particulate fluorocarbon polymer resin is selected from the group consisting of granular polytetrafluoroethylene (PTFE) resin, perfluoroalkoxy tetraethylene copolymer (PFA) resin, ethylenechlorotrifluoroethylene copolymer (E-CTFE) resin, tetrafluoroethylenehexafluoropropylene copolymer (FEP) resin, and poly(chlorotrifluoroethylene) (CTFE) resin, or a combination of any of the foregoing.

8. The biaxially planar oriented structure according to claim 5, wherein the polymeric additive is a polymeric ether selected from the group consisting of polyether ether ketone (PEEK) resin, polyether ketone (PEK) resin, and polyethersulfone (PES) resin, or a combination of any of the foregoing.

9. The biaxially planar oriented structure according to claim 2, wherein the at least one particulate material has a micron size of no more than 50 microns, or no more than 25 microns, or no more than 10 microns.

10. The biaxially planar oriented structure according to claim 2, wherein the at least one particulate material has a size of less than about 25 microns.

11. The biaxially oriented structure according to claim 2, wherein the at least one particulate has a size of less than about 10 microns.

12. The biaxially planar oriented structure according to claim 2, wherein the at least one particulate material is an inorganic filler selected from the group consisting of a nitride, a diborate, silcon carbide, zirconium carbide and tungsten carbide or a combination of any of the foregoing.

13. The biaxially planar oriented structure according to claim 2, wherein the at least one particulate material is a metal, powder or colloid particle selected from the group consisting of gold, silver, platinum, carbon, zirconium, copper, bronze and titanium, or a combination of any of the foregoing.

14. The biaxially planar oriented structure according to claim 2, wherein the at least one particulate material is a particulate filler selected from the group consisting of silicon carbide, graphite, molybdenum, chopped glass fibers, mica, ceramic oxide, carbon and silver oxide, or a combination of any of the foregoing.

15. The biaxially planar oriented structure according to claim 2, wherein the at least one particulate material is a micron size filler to improve the functional properties of PTFE in friction, wear, creep under load, and/or both thermal and electrical conductivity, and wherein said filler is a metal selected from the group consisting of bronze, copper, and magnesium, or a metal oxide selected from the group consisting of zirconium, titanium, silica, and aluminum, or a ceramic selected from the group consisting of silicon carbide and aluminum silicate.

16. The biaxially planar oriented structure according to claim 2, wherein the at least one particulate material is 0.5 to 3.0 micron silica particles with Angstrom size porosity, containing only 6 percent silica, SiO₂, by volume and 94 percent air by volume, wherein the filler porosity containing air, acts as a blowing agent expanding the air content during sintering thus blowing the gaseous contents of the micropores into the fluoropolymer structure, leaving the SiO₂ as an in situ filler.

17. The biaxially planar oriented structure according to claim 5, wherein at least one particulate matter is a polymer that bonds to polytetrafluoroethylene (PTFE) resin, wherein said polymer is selected from the group consisting of polyether ether ketone (PEEK), and polyether ketone (PEK), and said at least one other particulate matter is selected from the group consisting of silica, carbon and silicon carbide that also bonds to the polymer.

18. An apparatus for containing corrosive chemicals, such as employed in the chemical and pharmaceutical industry, wherein said apparatus comprises a vessel that is fitted with a lining structure comprising a biaxially planar oriented structure as described in claim 1.

19. The apparatus of claim 18, wherein the lining is at least about 0.09 inch thick, or the lining is at least about 0.6 to about 0.9 inch thick, or the lining is about 0.125 inch thick.

20. The apparatus of claim 18, wherein said biaxially oriented planar structure further comprises a plurality of at least one particulate material, wherein the particulate matter is dispersed homogeneously throughout the sheet, and wherein the particulate matter comprises between about 0.1% to about 90% by volume of the sheet.

21. The apparatus of claim 18, wherein the at least particulate material is a polymeric additive and/or an inorganic filler.

22. The apparatus of claim 18, wherein the at least one particulate material is a polymeric additive, wherein the polymeric additive is a polymeric ether selected from the group consisting of polyether ether ketone (PEEK) resin, polyether ketone (PEK) resin, and polyethersulfone (PES) resin, or a combination of any of the foregoing.

23. A method for preparing a porous biaxially planar oriented polytetrafluoroethylene resin structure, said method comprising:
a) adding fugitive pore former as a filler;
b) sintering the prepared composition; and
c) removing the fugitive pore former.

24. The method according to claim 23, wherein the particle size of the fugitive pore forming material predetermines the resulting pore size of the filter or membrane.

25. The method according to claim 23, wherein the fugitive pore former is removed using one or more of the following: i) by leaching with water, calcium chloride, potassium chloride and sodium chloride; ii) by dilute acids, calcium carbonate and sodium carbonate; iii) by heat and leaching with water, sodium tetraborate (borax); or iv) by sintering at a temperature above 342° C. in the presence of methylmethacrylate.

26. The method according to claim 23, wherein the porous biaxially planar oriented polytetrafluoroethylene resin structure comprises up to about 90% void volume of the structure.

27. The method according to claim 23, wherein an inorganic particulate matter such as silver oxide AgO₂, platinum, ruthenium dioxide RuO₂, or carbon is added as a particulate component to remain in situ with the polytetrafluoroethylene resin membrane matrix.

28. An asymmetric porous polytetrafluoroethylene resin membrane prepared by processing a plurality of separate unsintered membranes prepared according to the method of claim 23, wherein each membrane is prepared with a different size pore former, and wherein unsintered compositions are laminated with the application of pressure and heat up to 300° C. and wherein once laminated the laminate is sintered and the pore former removed.

29. A uniaxially oriented paste extrudate.

30. The uniaxially oriented paste extrudate according to claim 29, wherein the paste extrudate comprises at least one particulate matter.

31. The uniaxially oriented paste extrudate according to claim 29, wherein said extrudate is a fiber, said extrudate optionally comprising at least one particulate matter.

32. The uniaxially oriented paste extrudate according to claim 31, wherein the at least one particulate matter comprises about 0.1 % to about 90% by volume of the sintered extrudate.

33. A consolidated process feed composition comprising a biaxially oriented structure of claim 1, with or without hydrostatic coalescible wetting liquid for application as a coating for a woven or nonwoven matrix of fibers or other substrate capable of withstanding the sintering temperature of PTFE at 342° C. to 400° C., wherein the coating is capable of thick application that will withstand drying and sintering without cracking.

34. A method of forming or shaping a biaxially planar oriented hydrostatic pressure coalescible sheet structure of claim 1, said method comprising:
a) providing a biaxially planar oriented polytetrafluoroethylene hydrostatic pressure coalescible sheet;
b) applying a force to the sheet to form a complex shape;
c) optionally, heating the formed shape below the melting point of polytetrafluoroethylene resin while applying force; and
d) drying and sintering said formed shape.

35. The method according to claim 34, wherein step b) comprises blowing, compressing, deep drawing, vacuuming, or extruding the sheet.

36. The method according to claim 34, wherein the step c) comprises heating the sheet up to about 300° C., while applying the forming force.
